(19) United States
(12) Patent Application Publication
(10) Pub. No.: US 2016/0231045 A1
(43) Pub. Date: Aug. 11, 2016

(54) EVAPORATOR COVER

(71) Applicant: General Electric Company, Schenectady, NY (US)

(72) Inventors: Keith Wesley Wait, Louisville, KY (US); Joel Erik Hitzelberger, Louisville, KY (US)

(21) Appl. No.: 14/615,464

(22) Filed: Feb. 6, 2015

(51) Int. Cl. F25D 17/06; F04D 29/52; B23P 15/26

(52) U.S. Cl. CPC F25D 17/067; B23P 15/26; F04D 29/522

(57) ABSTRACT

An evaporator cover that includes a cover body integrally formed with a plurality of materials is provided. Each material of the plurality of materials has a different hardness. An air handler is mounted to the cover body. A related method for forming an evaporator cover with an additive process is also provided.

### FIELD OF THE INVENTION

The present subject matter relates generally to evaporator covers, such as evaporator covers for refrigerator appliances.

### BACKGROUND OF THE INVENTION

Refrigerator appliances generally include an evaporator for cooling air within a cabinet of the refrigerator appliances. To assist with cooling air inside the cabinet, certain refrigerator appliances include a fan that circulates air over the evaporator and through the cabinet. Evaporators commonly include metal fins or spines that facilitate heat transfer from air passing over the evaporator and refrigerant within the evaporator. While important for assisting with heat transfer, metal fins or splines can be bent or otherwise deformed when impacted. Deformed fins or splines may offer reduced heat transfer and negatively affect performance of the evaporator. In addition, evaporators may be unattractive.

To protect the evaporator and hide it from view, a cover is commonly placed over the evaporator within the cabinet. The evaporator cover also offers a convenient location to mount the fan for circulating air over the evaporator. However, mounting the fan to the evaporator cover can have certain drawbacks. For example, the evaporator cover may vibrate and generate an unpleasant or loud noise when the fan is mounted to the evaporator cover, and noisy appliances are a common consumer complaint.

Accordingly, an evaporator cover with features for reducing noise generated by a fan mounted to the evaporator cover would be useful.

### BRIEF DESCRIPTION OF THE INVENTION

The present subject matter provides an evaporator cover. The evaporator cover includes a cover body integrally formed with a plurality of materials. Each material of the plurality of materials has a different elastic modulus or hardness. An air handler is mounted to the cover body. A related method for forming an evaporator cover with an additive process is also provided. Additional aspects and advantages of the invention will be set forth in part in the following description, or may be apparent from the description, or may be learned through practice of the invention.

In a first exemplary embodiment, an evaporator cover is provided. The evaporator cover includes a cover body integrally formed with a plurality of materials. Each material of the plurality of materials has a different elastic modulus or hardness. An air handler is mounted to the cover body.

In a second exemplary embodiment, a method for forming an evaporator cover is provided. The method includes establishing three-dimensional information of the evaporator cover and converting the three-dimensional information of the evaporator cover from the step of establishing into a plurality of slices. Each slice of the plurality of slices defines a respective cross-sectional layer of the evaporator cover. The method also includes successively forming each cross-sectional layer of the evaporator cover with an additive process. After the step of successively forming, the evaporator cover includes a plurality of materials. Each material of the plurality of materials has a different elastic modulus or hardness.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance according to an exemplary embodiment of the present subject matter.

FIG. 2 provides a front, elevation view of the exemplary refrigerator appliance of FIG. 1 with refrigerator doors shown in an open position.

FIG. 3 provides a partial perspective view of a freezer chamber of the exemplary refrigerator appliance of FIG. 1.

FIG. 4 provides a partial perspective view of an evaporator cover and an air handler of the exemplary refrigerator appliance of FIG. 1.

FIG. 5 provides a partial elevation view of certain components of the evaporator cover of the exemplary refrigerator appliance of FIG. 1.

FIG. 6 illustrates a method for forming an evaporator cover according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

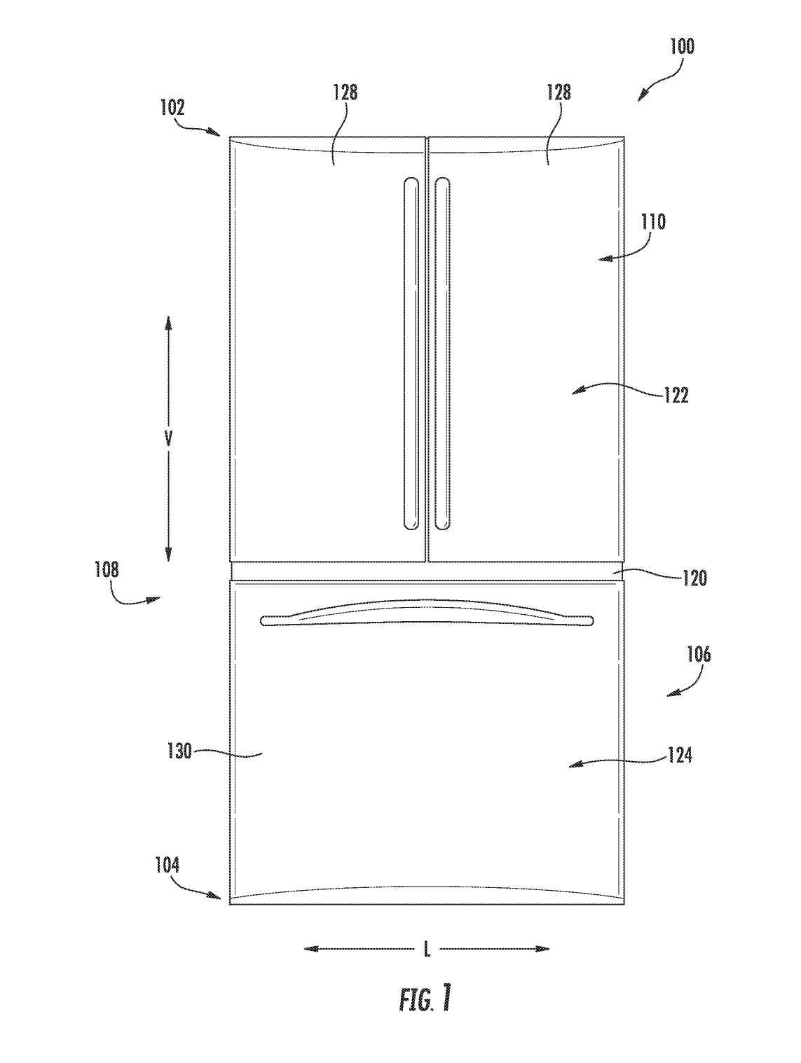

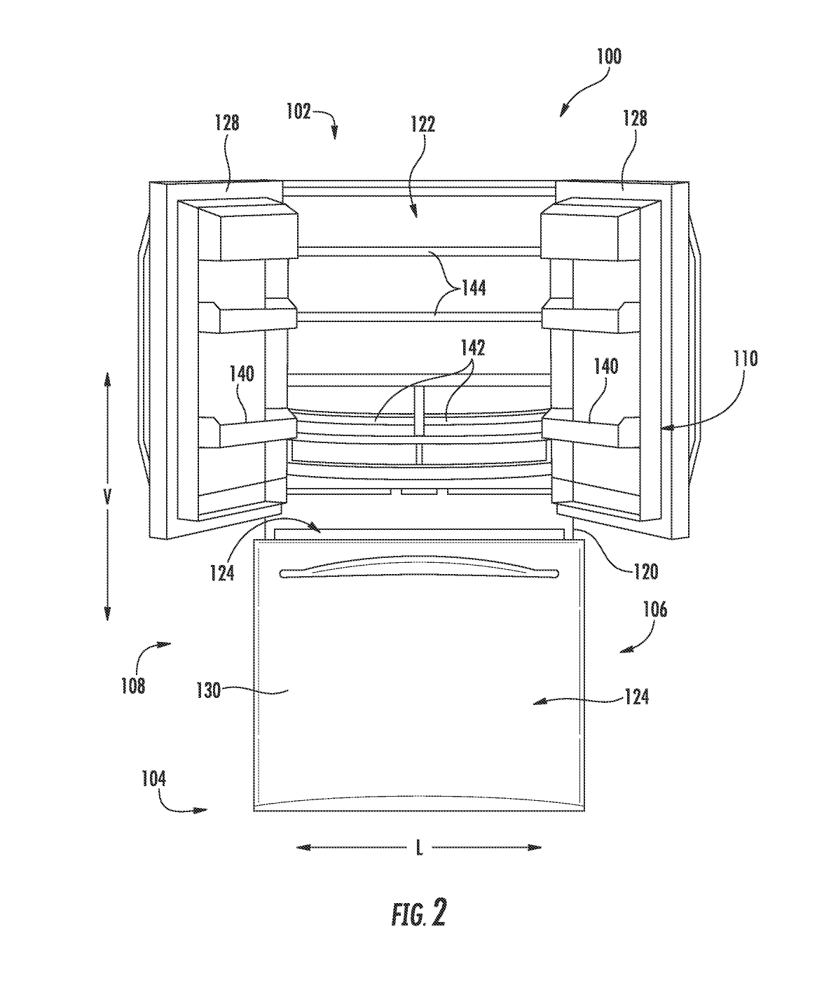

FIG. 1 provides a front, elevation view of a refrigerator appliance 100 according to an exemplary embodiment of the present subject matter with refrigerator doors 128 and freezer door 130 of the refrigerator appliance 100 shown in a closed position. FIG. 2 provides a front view of refrigerator appliance 100 with refrigerator doors 128 shown in an open position.

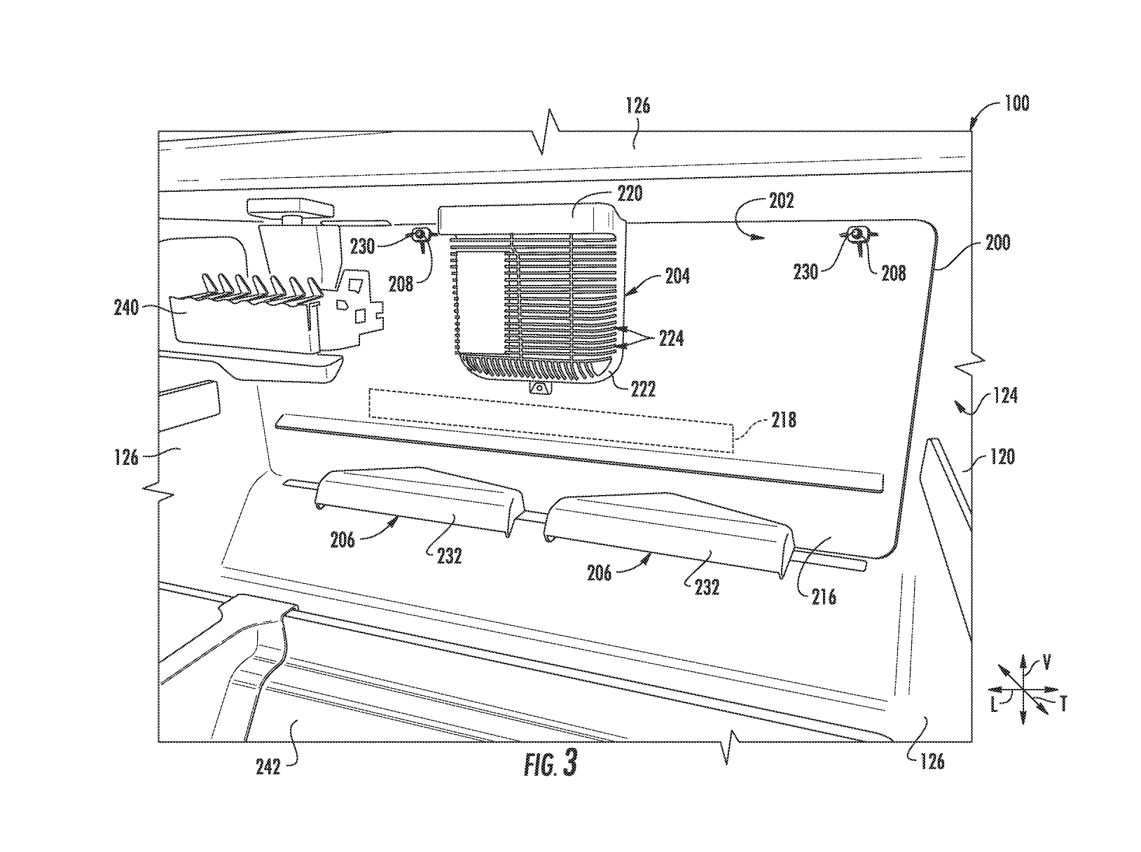

Refrigerator appliance 100 defines a vertical direction V, a lateral direction L, and a transverse direction T (see, e.g., FIG. 3), each mutually perpendicular to one another. Refrigerator appliance 100 includes a cabinet or housing 120 that extends between a top portion 102 and a bottom portion 104 along the vertical direction V and between a first side portion 106 and a second side portion 108 along the lateral direction L. As depicted, cabinet 120 defines chilled chambers for receipt of food items for storage. In particular, cabinet 120 defines fresh food chamber 122 positioned at or adjacent top portion 102 of cabinet 120 and a freezer chamber 124 arranged at or adjacent bottom portion 104 of cabinet 120. As such, refrigerator appliance 100 is generally referred to as a bottom mount refrigerator. However, while described in the context of refrigerator appliance 100, it will be understood that the present subject matter may be used in any other suitable appliance.

Refrigerator doors 128 are rotatably hinged to an edge of cabinet 120 for selectively accessing fresh food chamber 122. In addition, a freezer door 130 is arranged below refrigerator doors 128 for selectively accessing freezer chamber 124. As is discussed in greater detail below, freezer door 130 is slidably mounted to cabinet 120 adjacent freezer chamber 124. Refrigerator doors 128 and freezer door 130 are shown in the closed position in FIG. 1, and refrigerator doors 128 are shown in the open position in FIG. 2.

Turning now to FIG. 2, various storage components are mounted within fresh food chamber 122 to facilitate storage of food items therein as will be understood by those skilled in the art. In particular, the storage components include bins 140, drawers 142, and shelves 144 that are mounted within fresh food chamber 122. Bins 140, drawers 142, and shelves 144 are configured for receipt of food items (e.g., beverages and/or solid food items) and may assist with organizing such food items. As an example, drawers 142 can receive fresh food items (e.g., vegetables, fruits, and/or cheeses) and increase the useful life of such fresh food items.

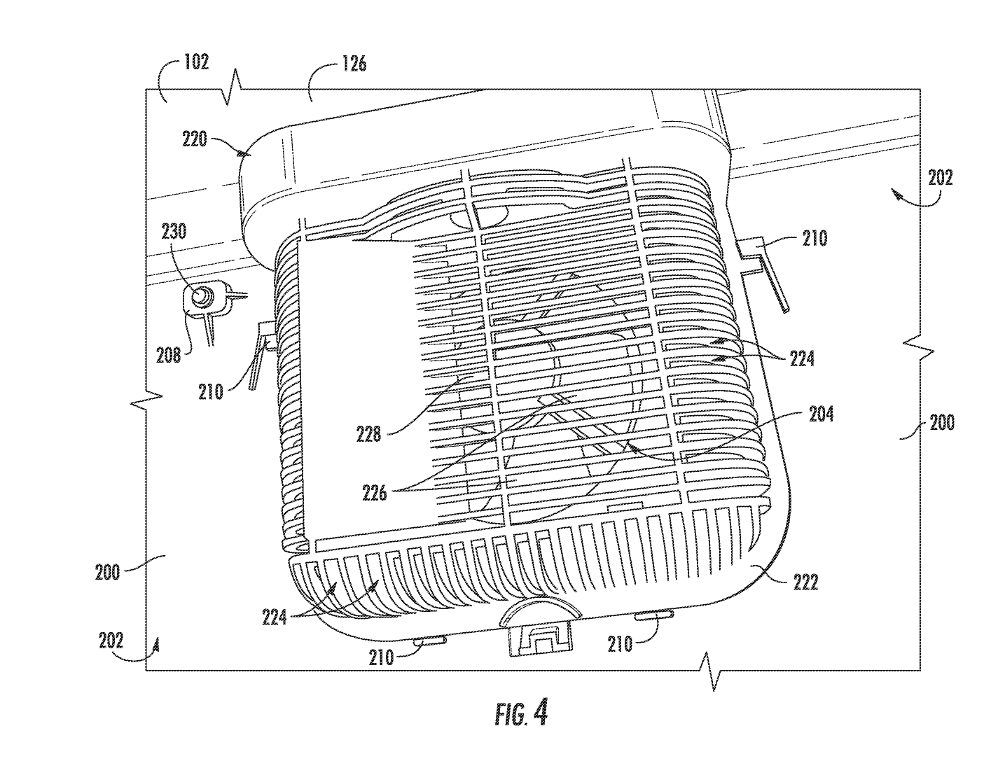

FIG. 3 provides a partial perspective view of freezer chamber 124 of refrigerator appliance 100. FIG. 4 provides a partial perspective view of an evaporator cover 200 and an air handler 220 of refrigerator appliance 100. As may be seen in FIG. 3, evaporator cover 200 is positioned at a back of freezer chamber 124 over an evaporator 218 (shown schematically in FIG. 3) of refrigerator appliance 100. Thus, evaporator cover 200 may be positioned between evaporator 218 and freezer chamber 124, e.g., along the transverse direction T. In particular, evaporator cover 200 may be positioned between evaporator 218 and an ice maker 240 and a basket assembly 242 disposed within freezer chamber 124, e.g., along the transverse direction T. Evaporator cover 200 may assist with limiting or preventing damage to evaporator 218, e.g., due to items within freezer chamber 124 impacting evaporator 218.

Evaporator cover 200 may be secured or mounted to cabinet 120, e.g., an inner liner 126 of cabinet 120, in any suitable manner. For example, as shown in FIGS. 3 and 4, evaporator cover 200 may defines posts 208, e.g., at or adjacent a top portion of evaporator cover 200. Fasteners 230 may extend through evaporator cover 200 and into cabinet 120 at posts 230. Thus, fasteners 230 may assist with mounting evaporator cover 200 to cabinet 120 at the back of freezer chamber 124. In addition, flanges of evaporator cover 200 may be received within inner liner 126 at a bottom portion of evaporator cover 200 in order to assist mounting evaporator cover 200 to cabinet 120 at the back of freezer chamber 124. Thus, the flanges of evaporator cover 200 may contact inner liner 126 in order to assist mounting evaporator cover 200 to cabinet 120.

Air handler 220 of refrigerator appliance 100 may also be mounted to evaporator cover 200. Air handler 220 assists with circulating air from freezer chamber 124 over evaporator 218 and back into freezer chamber 124. For example, evaporator cover 200 defines an inlet 204, e.g., at or adjacent the top portion of evaporator cover 200, and outlets 206, e.g., at or adjacent the bottom portion of evaporator cover 200. Air handler 220 is positioned at or adjacent inlet 204 of evaporator cover 200. Thus, air handler 200 urges air from freezer chamber 124 through inlet 204 of evaporator cover 200 to evaporator 218 when air handler 220 is activated. At evaporator 218, the air is chilled, and air handler 220 urges the chilled air back into freezer chamber 124 via outlets 206 of evaporator cover 200. Hoods 232 positioned at outlets 206 of evaporator cover 200 may assist with directing the chilled air towards a bottom of freezer chamber 124. In such a manner, air handler 220 may assist with circulating air from freezer chamber 124 over evaporator 218 behind evaporator cover 200.

Turning now to FIG. 4, air handler 220 includes a grill 222 that defines opening 224, blades 226 and a motor 228. Blades 226 of air handler 220 are rotatable with motor 228 in order to urge the flow of air through freezer chamber 124 as described above. Motor 228 of air handler 220 is mounted or fixed to grill 222, e.g., at or adjacent inlet 204 of evaporator cover 200. Air from freezer chamber 124 may flow through grill 222 via openings 224 to inlet 204 of evaporator cover 200.

Air handler 220 may be mounted to evaporator cover 200 in any suitable manner. For example, as shown in FIG. 4, grill 222 is positioned on evaporator cover 200, e.g., on an outer surface 202 of evaporator cover 200. Grill 222 is also mounted to evaporator 200, e.g., at or adjacent inlet 204 of evaporator cover 200. In particular, evaporator cover 200 defines brackets 210, e.g., that are disposed about inlet 204 of evaporator cover 200. Portions of grill 222 are disposed within or on brackets 210 in order to assist with securing grill 222 to evaporator cover 200. In certain exemplary embodiments, air handler 220 may be snap-fit to evaporator cover 200 with brackets 210.

As discussed in greater detail below, evaporator cover 200 also includes features for reducing or minimizing noise resulting from operation of air handler 220. Thus, evaporator cover 200 may reduce operating noise of refrigerator appliance 100. In particular, evaporator cover 200 may be constructed or configured to minimize or dampen vibrations resulting from operation of air handler 220.

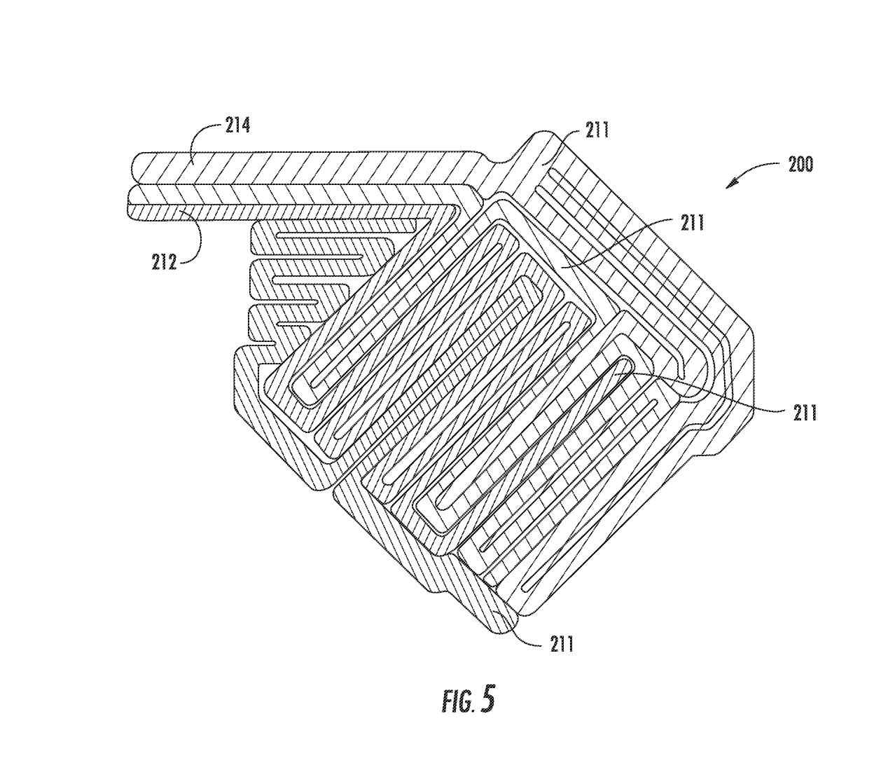

FIG. 5 provides a partial elevation view of certain components of evaporator cover 200. As may be seen in FIG. 5, the evaporator cover 200 (e.g., a main body of evaporator cover 200) may be constructed of or with a plurality of materials 211 that are integrally formed or mounted together. In particular, materials 211 may be meshed together such that each material of materials 211 is a single continuous piece of material as shown in the exemplary embodiment of FIG. 5. In alternative exemplary embodiments, evaporator cover 200 may include multiple discrete or separate pieces of each material of materials 211 within evaporator cover 200.

Materials 211 may include any suitable number of different materials. For example, materials 211 may include at least two different materials, at least three different materials, at least four different materials, at least five different materials, etc. In certain exemplary embodiments, materials 211 may include no more than ten materials. Each material of materials 211 may be any suitable material. For example, each material of materials 211 may be a polymer. In particular, evaporator cover 200 includes at least a first material 212 and a second material 214 in the exemplary embodiment shown in FIG. 5. The first material 212 may be an elastomer, such as a styrene-based thermoplastic elastomers, or an ethylene propylene diene monomer rubber. The second materials 214 may be a photopolymer, such as polystyrene, polypropylene or acrylonitrile butadiene styrene (ABS).

Each material of materials 211 has a different elastic modulus or Young's modulus. In addition, each material of materials 211 has a different hardness or durometer. By selecting a suitable elastic modulus and/or hardness (e.g., and position) for each material of materials 211, evaporator cover 200 may be configured or tuned for reducing or minimizing vibrations from air handler 220 during operation of air hander 220. In particular, the elastic modulus and/or hardness of each material of materials 211 may be selected such that resonant frequencies of air handler 220 are damped by evaporator cover 200. In such a manner, noise generated by air handler 220 during operation of air handler 220 may be reduced. As an example, each material of materials 211 may have an elastic modulus and/or hardness that is at least five percent greater or less than the other materials of materials 211.

Turning back to FIG. 3, a continuous outer coating 216 may be disposed or applied over materials 211 (FIG. 5) in order to form outer surface 202 of evaporator cover 200. The material of continuous outer coating 216 may be selected to match the color and/or appearance of inner liner 126 of cabinet 120 in freezer chamber 124. Thus, evaporator cover 200 may have the same or similar outer appearance as adjacent portions of cabinet 120 despite being constructed with materials 211 having different material properties and/or appearances. Continuous outer coating 216 may be a single continuous piece of plastic, such as polyurethane.

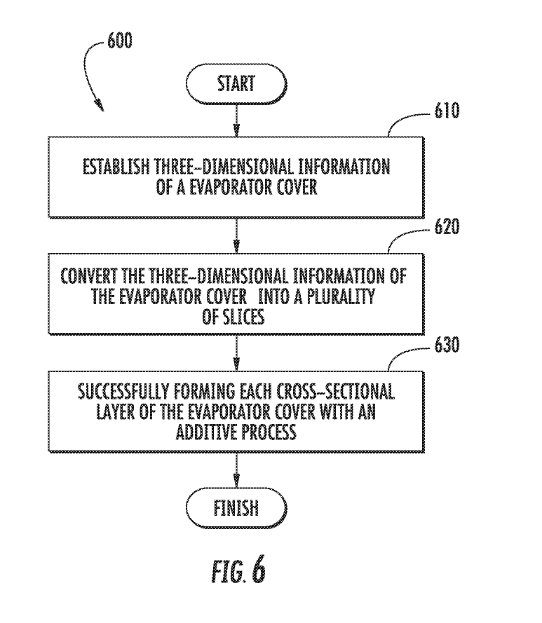

FIG. 6 illustrates a method 600 for forming an evaporator cover according to an exemplary embodiment of the present subject matter. Method 600 may be used to form any suitable evaporator cover. For example, method 600 may be used to form evaporator cover 200 (FIG. 3). Method 600 permits formation of various features of evaporator cover 200, as discussed in greater detail below. Method 600 includes fabricating evaporator cover 200 as a unitary evaporator cover, e.g., such that the various materials of evaporator cover 200 are integrally formed together. More particularly, method 600 includes manufacturing or forming evaporator cover 200 using an additive process, such as Stereolithography (SLA), Digital Light Processing (DLP), Laser Net Shape Manufacturing (LNSM) and other known processes. An additive process fabricates plastic components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 610, three-dimensional information of evaporator cover 200 is determined. As an example, a model or prototype of evaporator cover 200 may be scanned to determine the three-dimensional information of evaporator cover 200 at step 610. As another example, a model of evaporator cover 200 may be constructed using a suitable CAD program to determine the three-dimensional information of evaporator cover 200 at step 610. At step 620, the three-dimensional information is converted into a plurality of slices that each defines a cross-sectional layer of evaporator cover 200. As an example, the three-dimensional information from step 610 may be divided into equal sections or segments, e.g., along a central axis of evaporator cover 200 or any other suitable axis. Thus, the three-dimensional information from step 610 may be discretized at step 620, e.g., in order to provide planar cross-sectional layers of evaporator cover 200.

After step 620, evaporator cover 200 is fabricated using the additive process, or more specifically each layer is successively formed at step 630, e.g., by applying heat to melt and fuse a thermoplastic or polymerizing a resin using laser energy. The layers may have any suitable size. For example, each layer may have a size between about five ten-thousandths of an inch and about one thousandths of an inch. Evaporator cover 200 may be fabricated using any suitable additive manufacturing machine as step 630. For example, any suitable inkjet printer or laserjet printer may be used at step 630.

Utilizing method 600, evaporator cover 200 may have fewer components and/or joints than known evaporator covers. Also, method 600 may assist with forming evaporator cover 200 having materials 211 with different elastic moduli and/or hardnesses in order to reduce noise generated during operation of air handler 220. As a result, evaporator cover 200 may provide improved performance for refrigerator appliance 100, e.g., by reducing or minimizing noise generated by vibration of evaporator cover 200 during operation of air handler 220. Also, evaporator cover 200 may be less prone to breaks and/or be stronger when formed with method 600.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An evaporator cover, comprising:
a cover body integrally formed with a plurality of materials, each material of the plurality of materials having a different elastic modulus or hardness; and
an air handler mounted to the cover body.

2. The evaporator cover of claim 1, wherein the cover body is sized for covering an evaporator of a refrigerator appliance.

3. The evaporator cover of claim 1, wherein the cover body defines a plurality of mounting brackets, the mounting brackets of the cover body engaging the air handler in order to mount the air handler to the cover body.

4. The evaporator cover of claim 3, wherein the air hander is snap-fit to the cover body with the mounting brackets of the cover body.

5. The evaporator cover of claim 1, wherein the elastic modulus or hardness of each material of the plurality of materials is selected such that resonant frequencies of the air handler are damped by the cover body.

6. The evaporator cover of claim 1, wherein the cover body includes a continuous outer coating disposed over the plurality of materials.

7. The evaporator cover of claim 6, wherein the continuous outer coating is a single continuous piece of plastic.

8. The evaporator cover of claim 1, wherein the plurality of materials is meshed together such that each material of the plurality of materials is a single continuous piece of material.

9. The evaporator cover of claim 1, wherein the plurality of materials comprises a plurality of polymers.

10. The evaporator cover of claim 9, wherein the plurality of polymers includes an elastomer and a photopolymer.

11. A method for forming an evaporator cover, comprising:
establishing three-dimensional information of the evaporator cover;
converting the three-dimensional information of the evaporator cover from said step of establishing into a plurality of slices, each slice of the plurality of slices defining a respective cross-sectional layer of the evaporator cover; and
successively forming each cross-sectional layer of the evaporator cover with an additive process;
wherein, after said step of successively forming, the evaporator cover includes a plurality of materials, each material of the plurality of materials having a different elastic modulus or hardness.

12. The method of claim 11, wherein the plurality of materials includes an elastomer and a photopolymer.

13. The method of claim 11, further comprising mounting a fan to the evaporator cover after said step of successively forming.

14. The method of claim 13, wherein said step of mounting comprises snap-fitting the fan to the evaporator cover.

15. The method of claim 13, wherein the elastic modulus or hardness of each material of the plurality of materials is selected such that resonant frequencies of the fan are damped by the cover body.

16. The method of claim 11, further comprising applying a continuous outer coating over the plurality of materials after said step of successively forming.

17. The method of claim 16, wherein the continuous outer coating is a single continuous piece of plastic disposed over the plurality of materials after said step of successively forming.

18. The method of claim 11, wherein the plurality of materials is meshed together after said step of successively forming such that each material of the plurality of materials is a single continuous piece of material.

19. The method of claim 11, wherein the evaporator cover is sized for covering an evaporator of a refrigerator appliance after said step of successively forming.
